(19) United States
(12) Patent Application Publication
(10) Pub. No.: US 2022/0121718 A1
(43) Pub. Date: Apr. 21, 2022

(54) SYSTEMS AND METHODS OF GATHERING INFORMATION VIA BROWSER EXTENSION

(71) Applicants: Maurice John Barron, New York, NY (US); Derrick Shiu-Paon Chan, Ne\w York, NY (US); Dave John Fall, Towaco, NJ (US)

(72) Inventors: Maurice John Barron, New York, NY (US); Derrick Shiu-Paon Chan, Ne\w York, NY (US); Dave John Fall, Towaco, NJ (US)

(73) Assignee: Dagda.Digital, Inc., Towaco, NJ (US)

(21) Appl. No.: 17/506,531

(22) Filed: Oct. 20, 2021

Related U.S. Application Data
(60) Provisional application No. 63/094,246, filed on Oct. 20, 2020.

(51) Int. Cl. G06F 16/9535; H04L 29/08; G06F 16/955; G06N 20/00

(52) U.S. Cl. CPC G06F 16/9535; G06N 20/00; G06F 16/955; H04L 67/22

(57) ABSTRACT

Systems and methods for gathering information of a user via a browser extension. It includes receiving, by a website associated with the browser extension, the profile information of the user. It also includes storing, in a database, the profile information of the user as a user profile table. It transmits, by the database, the user profile table to a machine learning database. It identifies, by the machine learning database, a plurality of user classifications related to user profile table. The systems and methods gather, by the browser extension, the browsing data of the user while user browses the internet. It stores, in a cloud database server, the browsing data of the user. It determines, by the browser extension, at least one business condition of the user. It categorizes, by the browser extension, the user based on the business condition of the user determined by the browser extension.

### RELATED APPLICATION

This application claims the benefit of, and priority to, U.S. Provisional Patent Application No. 63/094,246, filed on Oct. 20, 2020, the entirety of this application is hereby incorporated herein by reference.

### TECHNICAL FIELD

The disclosure presented herein is generally directed towards a web browser and browser extension. More particularly, the disclosure relates to a computer-implemented system and method for gathering information of a user via one or more of a browser extension, a browser module, and a browser application.

### BACKGROUND

With the advent of technology, the use of the Internet as a medium of both personal communication and commercial activity has increased substantially. The internet has the potential to provide users with informative content on a limitless number of topics. However, the typical manner of using the Internet suffers from various drawbacks such as the user must specifically seek out the information he/she desires to obtain and may be unable to do this.

There are several problems with current approaches to provide the users with personalized and customized advertisements, promotions related to services, and products based on the browsing data in real-time. Therefore, there is a need for a computer-implemented system and method for gathering information of a user via one or more of a browser extension, a browser module, and a browser application that leverage machine learning tools.

Thus, in view of the above, there is a long-felt need in the industry to address the aforementioned deficiencies and inadequacies.

### SUMMARY

Computer-implemented systems and methods for gathering information of a user via one or more of a browser extension, a browser module, and a browser application are provided, as shown in and/or described in connection with at least one of the figures.

One aspect of the present disclosure relates to a computer-implemented method for gathering information of a user via one or more of a browser extension, a browser module, and a browser application. The computer-implemented method includes a step of receiving, by a website associated with the browser extension, the profile information of the user. The computer-implemented method includes a step of storing and classifying, in a database, the profile information of the user as a user profile table. The computer-implemented method includes a step of transmitting, by the database, the user profile table to a machine learning database. The computer-implemented method includes a step of creating and identifying, by the machine learning database, a plurality of user classifications related to the user profile table. The computer-implemented method includes a step of gathering, by the browser extension, the browsing data of the user while the user is browsing the internet. The computer-implemented method includes a step of storing, in a cloud database server, the browsing data of the user. The computer-implemented method includes a step of determining, by the browser extension, at least one business condition of the user. The computer-implemented method includes a step of categorizing, by the browser extension, the user based on the business condition of the user determined by the browser extension.

In an aspect, the business condition determined by the browser extension is indicative of one or more of: an appropriate business vertical suitable for the user, wherein the appropriate business vertical is selected from a plurality of business verticals; a current phase of the user within the business verticals; and a specific segment or a subsegment of the business verticals that the user should belong to.

In an aspect, the computer-implemented method includes a step of monitoring information of the user to determine segments that the user has not joined.

In an aspect, the segments that the user has not joined comprising a plurality of online properties selected from one or more of a plurality of websites, a plurality of social media platforms, a plurality of product offers, a plurality of service offers, and a plurality of advertisements.

In an aspect, the profile information of the user is classified as the user profile table by using one or more of a plurality of machine learning algorithms and a plurality of artificial intelligence algorithms in a storage mechanism.

In an aspect, the user classifications related to the user profile table are identified by using one or more of a plurality of machine learning algorithms and a plurality of artificial intelligence algorithms in the storage mechanism.

In an aspect, the computer-implemented method further includes a step of scoring the user information by using a scoring algorithm.

In an aspect, the browsing data is gathered by using a categorization and contextual keyword service to suggest the user to join one or more segments.

In an aspect, the computer-implemented method further includes a step of classifying a Uniform Resource Locator (URL) associated with the browser extension.

In an aspect, the URL is classified to build a plurality of applications.

An aspect of the present disclosure relates to a computer-implemented system for gathering information of a user via one or more of a browser extension, a browser module, and a browser application. The computer-implemented system includes a processor; and a memory.

The memory is communicatively coupled to the processor, wherein the memory stores instructions executed by the processor. The memory and processor are configured to receive, by a website associated with the browser extension, the profile information of the user. The memory and processor are configured to store and classify, in a database, the profile information of the user as a user profile table. The memory and processor are configured to transmit, by the database, the user profile table to a machine learning database. The memory and processor are configured to create and identify, by the machine learning database, a plurality of user classifications related to the user profile table. The memory and processor are configured to gather, by the browser extension, the browsing data of the user while the user is browsing the internet. The memory and processor are configured to store, in a cloud database server, the browsing data of the user. The memory and processor are configured to determine, by the browser extension, at least one business condition of the user. The memory and processor are configured to categorize, by the browser extension, the user based on the business condition of the user determined by the browser extension.

In an aspect, the business condition determined by the browser extension is indicative of one or more of: an appropriate business vertical suitable for the user, wherein the appropriate business vertical is selected from a plurality of business verticals; a current phase of the user within the business verticals; and a specific segment or a subsegment of the business verticals that the user should belong to.

In an aspect, the memory and processor are configured to monitor information of the user to determine segments that the user has not joined.

In an aspect, the segments that the user has not joined comprising a plurality of online properties selected from one or more of a plurality of websites, a plurality of social media platforms, a plurality of product offers, a plurality of service offers, and a plurality of advertisements.

In an aspect, the profile information of the user is classified as the user profile table by using one or more of a plurality of machine learning algorithms and a plurality of artificial intelligence algorithms in a storage mechanism.

In an aspect, the user classifications related to the user profile table are identified by using one or more of a plurality of machine learning algorithms and a plurality of artificial intelligence algorithms in the storage mechanism.

In an aspect, the memory and processor are configured to score the user information by using a scoring algorithm.

In an aspect, the browsing data is gathered by using a categorization and contextual keyword service to suggest the user to join one or more segments.

In an aspect, the memory and processor are configured to classify a Uniform Resource Locator (URL) associated with the browser extension.

In an aspect, the URL is classified to build a plurality of applications.

Another aspect of the present disclosure relates to non-transitory computer-readable storage medium storing executable instructions that, as a result of being executed by a memory and one or more processors of a computer system, cause the computer system to at least: receive, by a website associated with the browser extension, profile information of the user; store and classify, in a database, the profile information of the user as a user profile table; transmit, by the database, the user profile table to a machine learning database; create and identify, by the machine learning database, a plurality of user classifications related to the user profile table; gather, by the browser extension, browsing data of the user while the user is browsing the internet; store, in a cloud database server, the browsing data of the user; determine, by the browser extension, at least one business condition of the user; and categorize, by the browser extension, the user based on the business condition of the user determined by the browser extension.

In an aspect, the business condition determined by the browser extension is indicative of one or more of: an appropriate business vertical suitable for the user, wherein the appropriate business vertical is selected from a plurality of business verticals; a current phase of the user within the business verticals; and a specific segment or a subsegment of the business verticals that the user should belong to.

In an aspect, the memory and processor are configured to monitor information of the user to determine segments that the user has not joined.

In an aspect, the segments that the user has not joined comprising a plurality of online properties selected from one or more of a plurality of websites, a plurality of social media platforms, a plurality of product offers, a plurality of service offers, and a plurality of advertisements.

In an aspect, the profile information of the user is classified as the user profile table by using one or more of a plurality of machine learning algorithms and a plurality of artificial intelligence algorithms in a storage mechanism.

In an aspect, the user classifications related to the user profile table are identified by using one or more of a plurality of machine learning algorithms and a plurality of artificial intelligence algorithms in the storage mechanism.

In an aspect, the memory and processor are configured to score the user information by using a scoring algorithm.

In an aspect, the browsing data is gathered by using a categorization and contextual keyword service to suggest the user to join one or more segments.

In an aspect, the memory and processor are configured to classify a Uniform Resource Locator (URL) associated with the browser extension.

In an aspect, the URL is classified to build a plurality of applications.

Accordingly, one advantage of the present disclosure is that it provides a computer-implemented method and system to gather user information via a browser extension, browser module, or browser application (browser extension). The user installs the provider's (DAGDA.DIGITAL) browser extension and is directed to the provider's website. The user then creates a profile on the provider's website. The provider's website creates a user profile based on the information the user provides during registration. The user information plus additional information captured from the browser extension is utilized and evaluated by an algorithm to generate an overall DAGDA score. The provider's browser extension collects data by capturing the user's browsing and interaction with the website(s) and stores this information. An example of the types of tables and information stored include a browsing data table, a user profile table, user segmentation, and classification table, digital audiences table, DAGDA score table, and/or a user vertical value rating table.

Other embodiments and advantages will become readily apparent to those skilled in the art upon viewing the drawings and reading the detailed description hereafter, all without departing from the spirit and the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The accompanying drawings illustrate the embodiments of systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates a network implementation of the present computer-implemented system for gathering information of a user via one or more of a browser extension, a browser module, and a browser application, in accordance with one embodiment of the present disclosure.

FIG. 2 illustrates an operational flow diagram of a present computer-implemented system, in accordance with at least one embodiment.

FIG. 3 illustrates a flow diagram of machine learning algorithms detailing the data captured by the cloud database server, in accordance with at least one embodiment.

FIG. 4 illustrates a flow diagram of a machine learning algorithm detailing the computation of the Dagda score, in accordance with at least one embodiment.

FIG. 5 illustrates a flow diagram of a machine learning algorithm detailing the computation of Vertical rating, in accordance with at least one embodiment.

FIG. 6 illustrates a flow diagram of a machine learning algorithm detailing the computation of the User's Digital Value, in accordance with at least one embodiment.

FIG. 7 illustrates a flowchart of the computer-implemented method for gathering information of a user via one or more of a browser extension, a browser module, and a browser application, in accordance with an alternative embodiment of the present disclosure.

### DETAILED DESCRIPTION

The present description is best understood with reference to the detailed figures and description set forth herein. Various embodiments of the present system and method have been discussed with reference to the figures. However, those skilled in the art will readily appreciate that the detailed description provided herein with respect to the figures are merely for explanatory purposes, as the present system and method may extend beyond the described embodiments. For instance, the teachings presented and the needs of a particular application may yield multiple alternative and suitable approaches to implement the functionality of any detail of the present systems and methods described herein. Therefore, any approach to implement the present system and method may extend beyond certain implementation choices in the following embodiments.

According to an embodiment herein, the methods of the present disclosure may be implemented by performing or completing manually, automatically, and/or a combination of thereof. The term “method” refers to manners, means, techniques, and procedures for accomplishing any task including, but not limited to, those manners, means, techniques, and procedures either known to the person skilled in the art or readily developed from existing manners, means, techniques and procedures by practitioners of the art to which the present disclosure belongs. The persons skilled in the art will envision many other possible variations within the scope of the present system and method described herein.

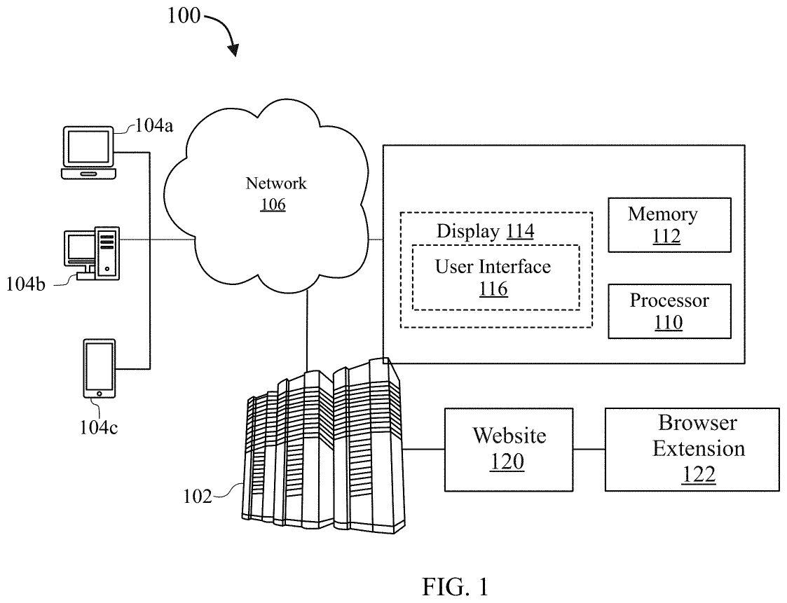

FIG. 1 illustrates a network implementation of the present computer-implemented system 100 for gathering information of a user via one or more of a browser extension, a browser module, and a browser application, in accordance with one embodiment of the present disclosure. The computer-implemented system 100 includes a processor 110, a memory 112, and a server 102. The memory 112 is communicatively coupled to the processor 110, wherein the memory 112 stores instructions executed by the processor 110. The memory 112 may be a non-volatile memory or a volatile memory. Examples of nonvolatile memory may include, but are not limited to flash memory, a Read Only Memory (ROM), a Programmable ROM (PROM), Erasable PROM (EPROM), and Electrically EPROM (EEPROM) memory.

Examples of volatile memory may include but are not limited to Dynamic Random-Access Memory (DRAM), and Static Random-Access memory (SRAM).

The processor 110 may include at least one data processor for executing program components for executing user- or system-generated requests. Processor 110 may include specialized processing units such as integrated system (bus) controllers, memory management control units, floating-point units, graphics processing units, digital signal processing units, etc. Processor 110 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 110 may be implemented using a mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 110 may be in communication with one or more input/output (I/O) devices via an I/O interface. I/O interface may employ communication protocols/methods such as, without limitation, audio, analog, digital, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

The computer-implemented system 100 requires a user to install the browser extension and register on a website associated with the browser extension within one or more computing devices 104 (for example, a laptop 104a, a desktop 104b, and a smartphone 104c). Other examples of the computing devices 104, may include but are not limited to a phablet and a tablet. The processor 110, memory 112, server 102, and the computing devices 104 are communicatively coupled over a network 106. Network 106 may be a wired or a wireless network, and the examples may include but are not limited to the Internet, Wireless Local Area Network (WLAN), Wi-Fi, Long Term Evolution (LTE), Worldwide Interoperability for Microwave Access (WiMAX), and General Packet Radio Service (GPRS).

Memory 112 further includes various modules that enable the present computer-implemented system 100 for gathering information via a browser extension, browser module, or browser application (browser extension). The present computer-implemented system 100 may further include a display 114 having a User Interface (UI) 116 that may be used by the user or an administrator to initiate a request to view the tailored and customized data and provide various inputs to the present computer-implemented system 100. Display 114 may further be used to display customized advertisements and promotions to the users. The functionality of the computer-implemented system 100 may alternatively be configured within each of the plurality of computing devices 104.

In an implementation, the memory 112 and processor 110 are configured to receive, by a website associated with the browser extension, the profile information of the user. The memory 112 and processor 110 are configured to store and classify, in a database, the profile information of the user as a user profile table. The memory 112 and processor 110 are configured to transmit, by the database, the user profile table to a machine learning database. The memory 112 and processor 110 are configured to create and identify, by the machine learning database, a plurality of user classifications related to the user profile table. The memory 112 and processor 110 are configured to gather, by the browser extension, the browsing data of the user while the user is browsing the internet. The memory 112 and processor 110 are configured to store, in a cloud database server, the browsing data of the user. The memory 112 and processor 110 are configured to determine, by the browser extension, at least one business condition of the user. The memory 112 and processor 110 are configured to categorize, by the browser extension, the user based on the business condition of the user determined by the browser extension.

In an embodiment, the business condition determined by the browser extension is indicative of one or more of: an appropriate business vertical suitable for the user, wherein the appropriate business vertical is selected from a plurality of business verticals; a current phase of the user within the business verticals; and a specific segment or a subsegment of the business verticals that the user should belong to. In an embodiment, the memory 112 and processor 110 are configured to monitor information of the user to determine segments that the user has not joined. In an embodiment, the segments that the user has not joined may comprise a plurality of online properties selected from one or more of a plurality of websites, a plurality of social media platforms, a plurality of product offers, a plurality of service offers, and a plurality of advertisements. In an embodiment, the profile information of the user is classified as the user profile table by using one or more of a plurality of machine learning algorithms and a plurality of artificial intelligence algorithms in a storage mechanism. In an embodiment, the user classifications related to the user profile table are identified by using one or more of a plurality of machine learning algorithms and a plurality of artificial intelligence algorithms in the storage mechanism. In an embodiment, the memory 112 and processor 110 are configured to score the user information by using a scoring algorithm. In an embodiment, the browsing data is gathered by using a categorization and contextual keyword service to suggest the user to join one or more segments. In an embodiment, the memory 112 and processor 110 are configured to classify a Uniform Resource Locator (URL) associated with the browser extension. In an embodiment, the URL is classified to build a plurality of applications.

According to an embodiment herein, the one or more computing devices 104 or user devices communicate with the website (hereinafter DAGDA.DIGITAL website or DAG website) and/or the browser extension (hereinafter DAGDA.DIGITAL Web Browser Extension or DAG extension). DAG website preferably includes one or more servers 102 configured to support the features and functionality described herein and at least one database in communication with the servers 102. In an implementation, the DAG website may include a firewall server, a web server, a file transfer protocol (FTP) server, a simple mail transfer protocol (SMTP) server, and other suitably configured servers. Although depicted as servers being commonly located, system 100 may utilize a distributed server architecture in which a number of servers communicate and operate with one another even though physically located in different locations.

As used herein, a “server” refers to a computing device or system configured to perform any number of functions and operations associated with system 100. Alternatively, a “server” may refer to software that performs the processes, methods, and/or techniques described herein. From a hardware perspective, system 100 may utilize any number of commercially available servers, e.g., the IBM AS/400, the IBM RS/6000, the SUN ENTERPRISE 5500, the COMPAQ PROLIANT ML570, and those available from UNISYS, DELL, HEWLETT-PACKARD, or the like. Such servers may run any suitable operating system such as UNIX, LINUX, or WINDOWS, and may employ any suitable number of microprocessor devices, e.g., the family of processors by INTEL or the processor devices commercially available from ADVANCED MICRO DEVICES, IBM, SUN MICROSYSTEMS, or MOTOROLA.

The server processors communicate with the memory (e.g., a suitable amount of random access memory), and an appropriate amount of storage or “permanent” memory. The permanent memory may include one or more hard disks, floppy disks, CD-ROM, DVD-ROM, magnetic tape, removable media, solid-state memory devices, or combinations thereof. In accordance with known techniques, the operating system programs and any server application programs reside in the permanent memory and portions thereof may be loaded into the system memory during operation. In accordance with the practices of persons skilled in the art of computer programming, the present disclosure is described below with reference to symbolic representations of operations that may be performed by one or more servers associated with system 100. Such operations are sometimes referred to as being computer-executed. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present disclosure are essentially the code segments that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

As used herein, the “computing device” or “user device” is any device or combination of devices capable of providing system information to an end-user of system 100. For example, a user device may be a personal computer, a television monitor, an Internet-ready console, a wireless telephone, a personal digital assistant (PDA), a home appliance, a component in an automobile, or the like. User devices are preferably configured in conventional ways known to those skilled in the art. In addition, user devices may be suitably configured to function in accordance with certain aspects of the present disclosure, as described in more detail herein.

System 100 is capable of supporting the integrated use of such multiple devices in a manner that enables the user to access the DAG website and utilize the features of the present disclosure via the different user devices. In addition, system 100 is preferably configured to support a plurality of end-users, each of which may have personal data or individual preferences and display settings associated therewith. Such user-specific characteristics may be suitably stored in the database and managed by system 100.

In accordance with one preferred embodiment, computing devices 104 communicate with the DAG website via network 106, e.g., a local area network (LAN) a wide area network (WAN), or the Internet. In the preferred embodiment, the network is the Internet and each of the individual user devices is configured to establish connectivity with the Internet using conventional application programs and conventional data communication protocols. For example, each user device preferably includes a web browser application such as Google Chrome or Firefox, and each user device may be connected to the Internet via an internet service provider (ISP). In a practical embodiment, user devices and the DAG website are connected to the network through various communication links. As used herein, a “communication link” may refer to the medium or channel of communication, in addition to the protocol used to carry out communication over the link. In general, a communication link may include, but is not limited to, a telephone line, a modem connection, an Internet connection, an Integrated Services Digital Network (ISDN) connection, an Asynchronous Transfer Mode (ATM) connection, a frame relay connection, an Ethernet connection, a coaxial connection, a fiber-optic connection, satellite connections (e.g., Digital Satellite Services), wireless connections, radio frequency (RF) connections, electromagnetic links, two-way paging connections, and combinations thereof.

As mentioned above, system servers preferably communicate with one or more databases. A given database may be maintained at the DAG website or maintained by a third party external to the overall architecture of system 100. The database is preferably configured to communicate with system servers in accordance with known techniques such as the TCP/IP suite of protocols. In a practical embodiment, the database may be realized as a conventional SQL database, e.g., an ORACLE-based database.

The databases preferably contain some or all of the following data (without limitation): collected tables (browsing data table, user profile table, etc.), and any other information necessary to carry out the techniques of the present disclosure as described herein. The end-user profiles may include names, email addresses, account information, and mailing addresses.

As described briefly above, system servers preferably include a web server, which may be configured conventionally to provide web navigation capabilities in connection with the Internet. In a practical embodiment, the web server may employ commercially available applications such as APACHE, MICROSOFT IIS, or the like. The web server may operate to manage, process, and deliver HTML documents (such as web pages and formatted data) in response to requests from the various user devices.

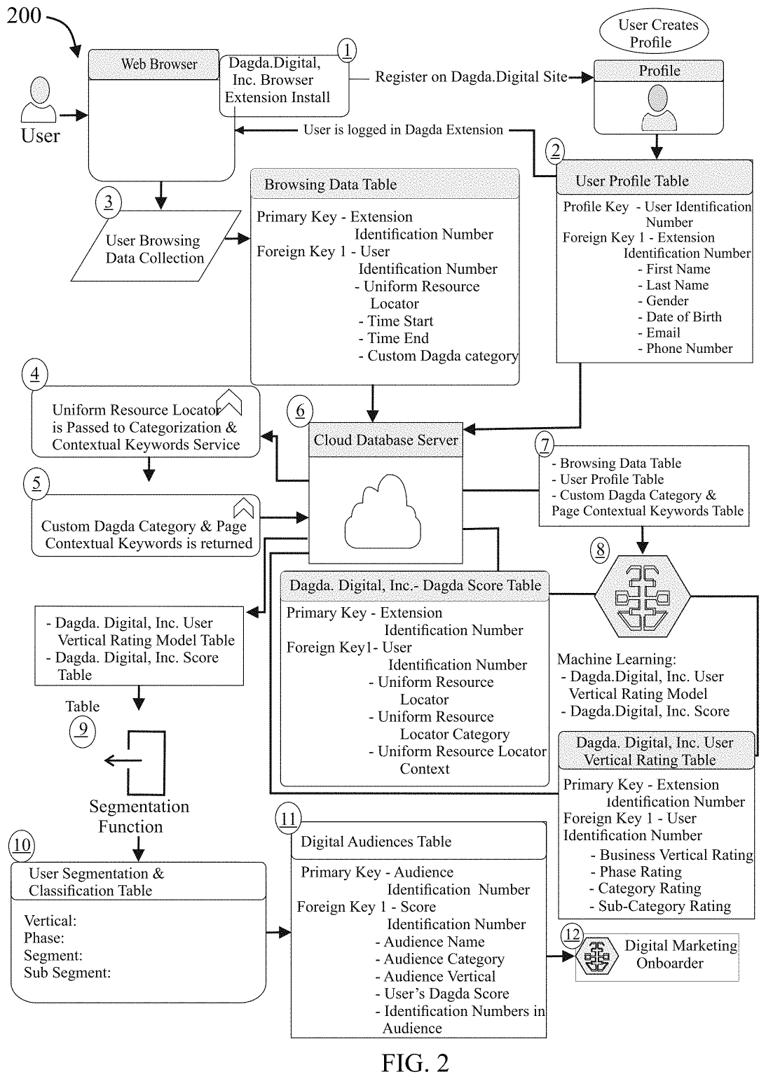

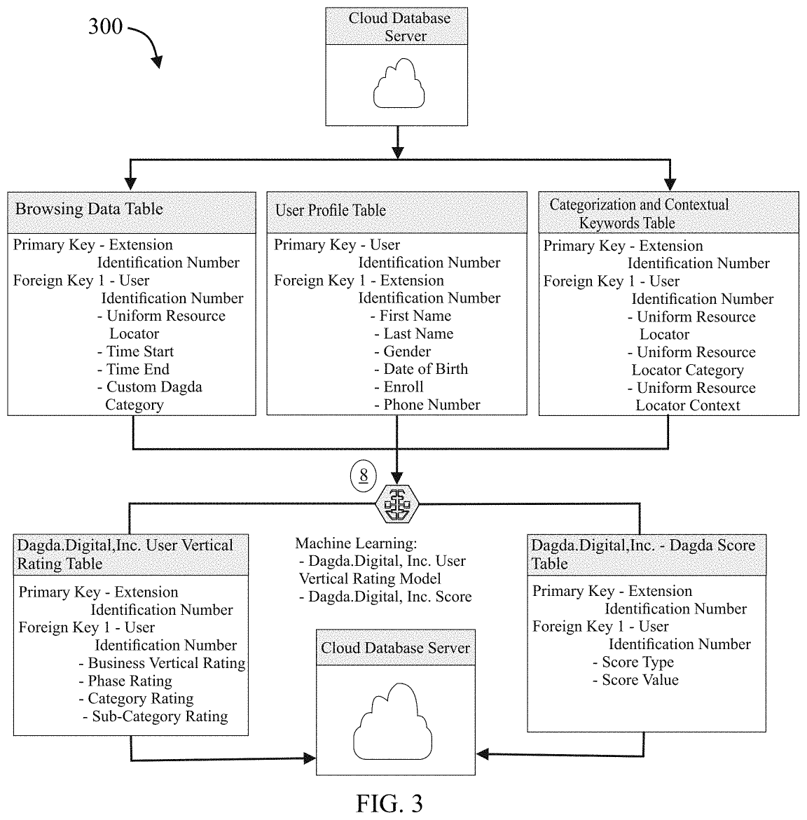

FIG. 2 illustrates an operational flow diagram of a present computer-implemented system, in accordance with at least one embodiment. FIG. 3 illustrates a flow diagram 300 of machine learning algorithms detailing the data captured by the cloud database server, in accordance with at least one embodiment. FIG. 2 and FIG. 3 are explained in conjunction with each other. The system 100 and method includes a first step, which is user registration. This step includes: 1) User opens Web Browser on their Personal Computer or Laptop; 2) User downloads DAG browser extension through a Web Browser's Store; 3) User installs DAG browser extension; 4) After Installation, User is directed to DAG website; 5) On DAG website, User is provided online form field to register and create user a profile; 6) User's profile information is captured and securely stored on DAGDA.DIGITAL, Inc.'s “User Profile Table” database.

The “User Profile Table” database consists of: 1. User Identification Number=>Primary Key; 2. Browser extension Identification Number=>Foreign Key; 3. First Name; 4. Last Name; 5. Gender; 6. Date of Birth; 7. Email; and 8. Phone Number. The first step further includes 7) User is returned to designated Web Browser Startup page or google.com. Simultaneously, the user is still logged into the DAG browser extension

Further, in the second step, the user's profile data is categorized and stored on DAGDA.DIGITAL, Inc.'s secured “User Profile Table” Cloud Database Server. In this step, 1) “User Profile Table” is sent to DAGDA.DIGITAL, Inc.'s “Machine Learning” database where algorithms will automatically create and identify “User Classifications”; 2) “User Classifications” data is utilized and evaluated via “DAGDA.DIGITAL, Inc.'s Dagda Score Artificial Intelligence” algorithm; 3) Algorithms will automatically create and update the “DAGDA.DIGITAL, Inc.'s Dagda Score Table” database.

The DAGDA.DIGITAL, Inc.'s—Dagda Score Table includes 1) Score Identification Number=>Primary Key; 2) User Identification Number=>Foreign Key I; 3) Score Type; 4) User Score Value.

In a third step, 1) the user is returned to the designated Web Browser Startup page or google.com. Simultaneously, the user is still logged into the DAG browser extension; 2) As the user continues to browse the internet, the DAG browser extension collects selected data, which is in line with the Interactive Advertising Bureau's (IAB) “Standards and Best Practices”. 3) User's browsing data is collected in real-time, categorized, and stored on DAGDA.DIGITAL, Inc.'s secured cloud database server. The browsing data table includes: 1) Browser extension Identification Number=>Primary Key; 2) User Identification Number=>Foreign Key I; 3) Uniform Resource Locator (URL); 4) Time start; 5) Time End; and 6) Interactive Advertising Bureau Category.

Further, in the third step, 4) Browsing Data Table is sent to DAGDA.DIGITAL, Inc.'s “Machine Learning” database where data will be evaluated via “DAGDA.DIGITAL, Inc.'s Dagda Score Artificial Intelligence” algorithm; 5) Browsing Data Table is also sent to Categorization and Contextual Keyword Service.

In a fourth step, Uniform Resource Locator is passed to categorization and contextual keywords service. In the fourth step, 1) the captured Uniform Resource Locator (URL) is passed to a web service where a Website Categorization API retrieves the website content and meta tags, extracts text, and assigns categories based on natural language processing and aligns this with the custom Dagda categories and our own Dagda taxonomy; and 2) The service also indexes the content on the page and returns a list of the most relevant contextual keywords based on the page content.

In fifth step, the custom Dagda category and page context is returned. In this step, 1) the data is packaged up into a JSON response and is pushed to our Cloud Database Server instance to be stored and used by our teams to model our users.

In a sixth step, 1) DAGDA.DIGITAL, Inc. will maintain a cloud infrastructure (currently google cloud, but can be any cloud service) to house and store the data we receive from the Uniform Resource Locator classification engine as well as any additional data gathered from users and generated by our applications; 2) This helps to build proprietary applications which can run in the cloud and can use sophisticated analytics and Artificial Intelligence functions, utilize data storage to take advantage of cost efficiencies versus hosting our own data infrastructure; 3) This cloud infrastructure will allow us to run our custom applications and store data as needed for our business.

In a seventh step, 1) The following data tables will be sent to DAGDA.DIGITAL, Inc.'s “Machine Learning” database where data will be evaluated via “DAGDA.DIGITAL, Inc.'s Dagda Score Artificial Intelligence” algorithm and “DAGDA.DIGITAL, Inc.'s Vertical Rating System Artificial Intelligence”.

In an eighth step, a proprietary vertical value rating is a system 100 which allows Dagda to analyze, process and output a rating for a given user based on the following inputs: 1. The data can be received directly from the user; 2. The user's web browsing data collected by DAG browser extension; 3. From the web services which categorize and provide contextual keywords based on the URLs the user visits.

Dagda will use machine learning and custom algorithms to weigh the above elements and signals to determine the following: 1. Which business vertical the user should belongs to; and 2. The user's current phase within that vertical. Phase defines which stage a user is currently in during a user journey/buying cycle. Phases: I. Announce—User is unaware of the product/service and/or offering in a particular vertical; II. Research I Consideration—User is aware of product/service and/or offering and educating themselves on the product/service and/or offering and other options; III. Intention—User is actively searching for product/service and or offering and shows behaviors indicating about to purchase product/service and or offering; IV. Action—User purchases product/service and or offering. Dagda further determines thee specific segment or subsegments that the user should belong to.

The objective of the present system is to maximize the satisfaction of our users based on the digital audiences they have been added to. This means they should achieve greater satisfaction by being targeted with more relevant, timely, and user-specific advertising when browsing the web, and the advertiser/marketer is utilizing Dagda's data.

To achieve the aforementioned objectives, the present computer-implemented system 100 will:
1) Define guidelines to measure success.
   a. This can be as simple as, should a user be added to a given segment based on very defined signals we have about them? (binary problem).
      i. i.e., Should the user be added to the segment?—Yes or No
   b. More subjective analysis of the signals is utilized by looking at additional data sets and applying contextual scoring or ranking to define success.
      i. i.e., time shorten/reduced from one phase to another

The objective of the present system is to make sure that the user's satisfaction is greater when they see digital advertisements based on Dagda data over another data provider.
2) Define the model features:

The characteristic of the data received from the categorization API needs to be defined so that it can be used to predict how relevant each signal we receive is going to be when assigned to a digital segment. A feature could be: I. The number of specific contextual keywords on a given page; II. When the page was updated; III. The amount of time our user has spent on that page; IV. How unique it is compared to other content on the web.

The model of the present disclosure will have both positive and negative weights, in which certain features will increase relevancy while others will have a negative effect on the relevancy.
3) Train the machine learning algorithm. Using training, validation, and test datasets.

Segment ratings are sorted by descending order-based ratings against all other users in that segment. Then the algorithm will test, learn and refine the model.
4) Evaluate the success

The objective of the present system is to maximize user satisfaction. The present system can use online signals such as a user's propensity to click on an ad where our data was used if they continue to be added to a given segment even though they haven't interacted with any targeted ads or how they update or remove themselves from segments logging into the Dagda portal.

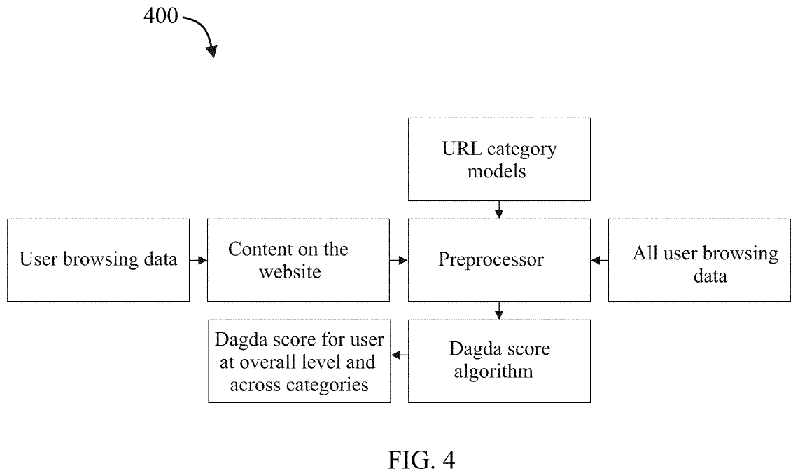

FIG. 4 illustrates a flow diagram of a machine learning algorithm detailing the computation of the Dagda score, in accordance with at least one embodiment. Further, DAGDA.DIGITAL, Inc.'s Dagda Score is described. The algorithm utilizing the outlined data points in Appendix A that will generate a user's “Dagda Score” of 1 through 100 includes each custom Dagda category that the user has been determined to be part of by evaluating the user's online interests, intents, preferences, and purchasing behaviors.

Key Components of evaluation include inferred data set; consented/explicit data set; and data that will not be captured.

The inferred data set includes 1) Users' internet browsing history within the past n number of days to determine interest vs purchase intent; 2) Time spent within a particular internet site; 3) Time spent within a particular category of websites based on custom Dagda categories; 4) Device type; 5) DAGDA.DIGITAL, Inc. vertical rating model.

The consented/explicit data set includes 1) feedback from served online advertisements to determine interest or purchased already or irrelevant; 2) User confirmation of inclusion of categories via DAGDA.DIGITAL user portal/user interface; 3. User confirmation of purchase intent via DAGDA.DIGITAL user portal/user interface will increase Dagda Score; 4) User feedback of removal from an inferred audience category will increase overall Dagda score while removing the user from the audience.

In one embodiment, the data that will not be captured includes and is not limited to 1. Adult content; 2. Wealth management websites like, for example, but not limited to: Banking, retirement accounts, brokerage; 3. The email includes and is not limited to: Gmail, yahoo mail, AOL 4. Government Agencies or military. The algorithm will continuously evaluate data on a rolling n number of days basis and re-calculate a user's “Dagda Score” on an n number of days basis. Further, DAGDA.DIGITAL, Inc.'s Vertical Value Rating—audience creation is described. The daily “Vertical Value Rating” output by the user by Audience Category will be saved within a database for historical analysis and the user will be able to access the data through DAGDA.DIGITAL User Portal/User Interface. Once the users' “Vertical Value Rating” per custom Dagda category has been calculated, all the users will be bucketed into audience categories in accordance with the IAB standards. A user will be able to be in multiple audience categories at the same time. When each audience category reaches a size threshold (a certain amount of users), the audience will then be split into 3 sub-audience categories based on the users' “Vertical Value Rating” range. An example is below:

| Audience Category | Sub Audience | Vertical Value Rating |
|---|---|---|
| Automotive | Automotive - 1 | 7-10 |
| Automotive | Automotive - 2 | 4-6 |
| Automotive | Automotive - 3 | 1-3 |
| Clothing | Clothing - 1 | 7-10 |
| Clothing | Clothing - 2 | 4-6 |
| Clothing | Clothing - 3 | 1-3 |

All Audience Categories and Sub-audience Categories will be made available via a digital onboarding partnership or a direct integration with a Demand Side platform, such as The Trade Desk, or other digital technology platforms to allow advertisers/marketers to purchase DAGDA.DIGITAL's Audiences for their online marketing advertising campaigns.

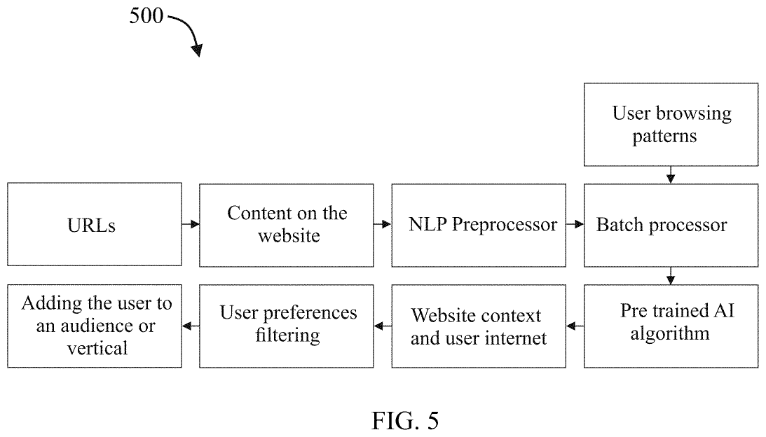

FIG. 5 illustrates a flow diagram 500 of a machine learning algorithm detailing the computation of vertical rating, in accordance with at least one embodiment. Once the users' daily “Vertical Value Rating” per custom Dagda category has been calculated, all the users will be bucketed into audience categories in accordance with the IAB standards. In an embodiment, the user will be able to be in multiple audience categories at the same time. The daily “Vertical Value Rating” output by the user by Audience Category will be saved within a database for historical analysis and the user will be able to access the data through DAGDA.DIGITAL's User Portal/User Interface. Within the “DAGDA.DIGITAL, Inc.'s Dagda Score details section of the DAGDA.DIGITAL, Inc.'s User Portal/User Interface, the user will be given the ability to confirm or “opt-out” of each audience category that the user has been identified with. This feedback will alter the User's Dagda Score per category.

The last day of every month, the user's Dagda Score and amount of “Sold Data” that is associated with the user will be calculated.

In a ninth step, a segmentation function is performed which includes 1) once the rating process has been completed, the present system uses a function to process this information and assign users to the relevant vertical, phase, and segments defined by DAGDA.DIGITAL, Inc.

In a tenth step, a user segmentation and classification are performed in which 1) these segments are updated on a defined frequency and stored in specific database tables which can be used to create specific advertising segments based on a client's needs or requirements.

In the eleventh and twelfth steps, digital audiences and digital marketing onboarder steps are performed consecutively. 1. Using a digital onboarding platform such as Liveramp, we will match our Dagda users via PII data such as email, phone, or address to non-PII data such as a cookie or digital ID. 2. When a specific segment or audience is needed to be transferred to a client, the present system will pass the digital onboarding partner the anonymized digital ID they provided when matching to our users and the taxonomy of the digital segments they are receiving. 3. The onboarding partner will then distribute the segment to the location defined by the client.

Appendix A: Dagda Score data set for evaluation:
gender;
date of birth;
browser extension identification number;
user identification number;
uniform resource locator—(URL time start);
time end;
Interactive Advertising Bureau Category.

Appendix B: DAGDA.DIGITAL User Portal/User Interface

Once users download the DAG browser extension and registers within the DAG website, registered users will be able to log in with a username and password to DAGDA.DIGITAL, Inc.'s user portal/user interface within the DAG website.

The user is brought to DAGDA.DIGITAL, Inc.'s user portal/user interface and the user portal/user interface displays the following:
1. Current DAGDA.DIGITAL, Inc.'s Dagda Score
2. Current month's rewards
3. Top 10 categories that the user has been identified to part of:
   a. with an indication that the category is confirmed or inferred
   b. DAGDA.DIGITAL, Inc.'s Dagda score associated with the user and the particular category
4. Methods to increase DAGDA.DIGITAL, Inc.'s Dagda Score. The user portal/user interface will have links to the following:
1. Profile
   a. For editing/updating:
      i. email address
      ii. phone number
      iii. password
      iv. Audience/Category preferences selection
2. DAGDA.DIGITAL, Inc.'s Dagda Score details
   a. Current score and trends
   b. Historical score and trends
   c. Opt-out options for custom Dagda categories and websites
3. Terms and Conditions
   a. Simple bullet points of key items
   b. Link to a PDF download of part or all of the legal document(s)
4. Privacy policy
   a. Simple bullet points of key items
   b. Link to a PDF download of part or all of the legal document(s)
5. Education videos that include:
   a. How data is gathered
   b. Why am I associated with a Category
   c. What data is gathered
   d. How the internet works
   e. How data is sold
   f. How data is used
   g. How DAGDA.DIGITAL rewards user
6. Log out

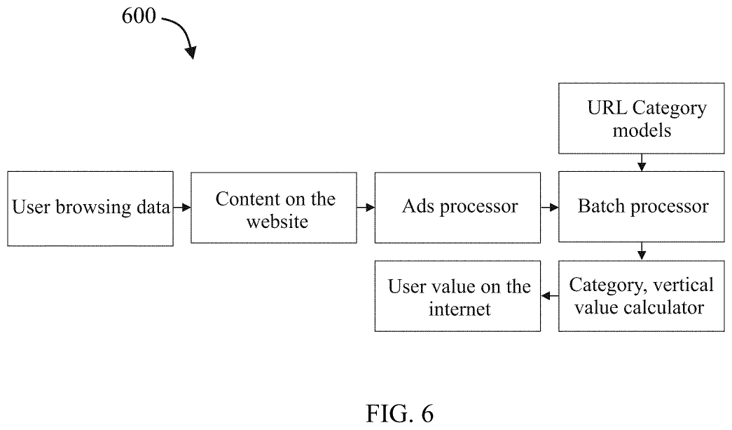

FIG. 6 illustrates a flow diagram of a machine learning algorithm detailing the computation of the user's digital value, in accordance with at least one embodiment. FIG. 6 depicts that the user browsing data is received along with the content on the website. The user browsing data along with the content on the website is processed by an ads processor. Further, a batch processor receives the data from the advertisements processor and URL category models. The batch processor categorizes and processes the data through a vertical value calculator. Lastly, the batch processor computes the user's digital value.

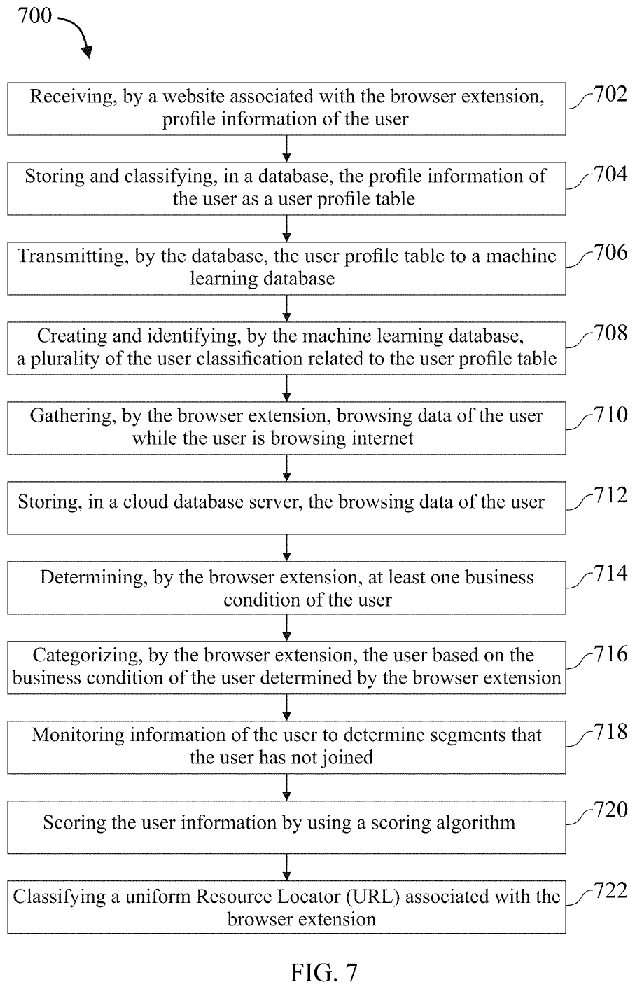

FIG. 7 illustrates a flowchart of the computer-implemented method for gathering information of a user via one or more of a browser extension, a browser module, and a browser application, in accordance with an alternative embodiment of the present disclosure. The computer-implemented method includes step 702 of receiving, by a web site associated with the browser extension, the profile information of the user. The computer-implemented method includes step 704 of storing and classifying, in a database, the profile information of the user as a user profile table. The computer-implemented method includes step 706 of transmitting, by the database, the user profile table to a machine learning database. The computer-implemented method includes step 708 of creating and identifying, by the machine learning database, a plurality of user classifications related to the user profile table. The computer-implemented method includes step 710 of gathering, by the browser extension, the browsing data of the user while the user is browsing the internet. The computer-implemented method includes step 712 of storing, in a cloud database server, the browsing data of the user.

The computer-implemented method includes step 714 of determining, by the browser extension, at least one business condition of the user. In an embodiment, the business condition determined by the browser extension is indicative of one or more of: an appropriate business vertical suitable for the user, wherein the appropriate business vertical is selected from a plurality of business verticals; a current phase of the user within the business verticals; and a specific segment or a subsegment of the business verticals that the user should belong to. The computer-implemented method includes step 716 of categorizing, by the browser extension, the user based on the business condition of the user determined by the browser extension.

In an embodiment, the computer-implemented method includes a step of monitoring information of the user to determine segments that the user has not joined. In an embodiment, the segments that the user has not joined comprising a plurality of online properties selected from one or more of a plurality of websites, a plurality of social media platforms, a plurality of product offers, a plurality of service offers, and a plurality of advertisements. In an embodiment, the profile information of the user is classified as the user profile table by using one or more of a plurality of machine learning algorithms and a plurality of artificial intelligence algorithms in a storage mechanism. In an embodiment, the user classifications related to the user profile table are identified by using one or more of a plurality of machine learning algorithms and a plurality of artificial intelligence algorithms in the storage mechanism. In an embodiment, the computer-implemented method further includes step 720 of scoring the user information by using a scoring algorithm. In an embodiment, the browsing data is gathered by using a categorization and contextual keyword service to suggest the user to join one or more segments. In an embodiment, the computer-implemented method further includes step 722 of classifying a Uniform Resource Locator (URL) associated with the browser extension. In an embodiment, the URL is classified to build a plurality of applications.

Unless otherwise defined, all terms (including technical and scientific terms) used in this disclosure have the same meaning as commonly understood by one of ordinary skill in the art to which this disclosure belongs. It is to be understood that the phrases or terms employed of the present disclosure are for description and not of limitation. As will be appreciated by one of ordinary skill in the art, the present disclosure may be embodied as a device, system, and method, or computer program product. Further, the present disclosure may take the form of a computer program product on a computer-readable storage medium having computer-usable program code embodied in the medium. The present systems and methods have been described above with reference to specific examples. However, other embodiments and examples than the above description are equally possible within the scope of the present disclosure. The scope of the disclosure may only be limited by the appended patent claims. Even though modifications and changes may be suggested by the persons skilled in the art, it is the intention of the inventors and applicants to embody within the patent warranted heron all the changes and modifications as reasonably and properly come within the scope of the contribution the inventors and applicants to the art. The scope of the embodiments of the present disclosure is ascertained with the claims to be submitted at the time of filing the complete specification.

What is claimed is:

1. A computer-implemented method for gathering information of a user via a browser extension comprising:
receiving, by a website associated with the browser extension, profile information of the user;
storing, in a database, the profile information of the user as a user profile table;
transmitting, by the database, the user profile table to a machine learning database;
identifying, by the machine learning database, a plurality of user classifications related to the user profile table;
gathering, by the browser extension, browsing data of the user while the user is browsing the internet;
storing, in a cloud database server, the browsing data of the user;
determining, by the browser extension, at least one business condition of the user; and
categorizing, by the browser extension, the user based on the business condition of the user determined by the browser extension.

2. The computer-implemented method according to claim 1, wherein the business condition determined by the browser extension is indicative of one or more of:
an appropriate business vertical suitable for the user, wherein the appropriate business vertical is selected from a plurality of business verticals;
a current phase of the user within the business verticals; and
a specific segment or a subsegment of the business verticals that the user should belong to.

3. The computer-implemented method according to claim 1, comprising monitoring information of the user to determine segments that the user has not joined.

4. The computer-implemented method according to claim 3, wherein determining the segments that the user has not joined comprises a plurality of online properties selected from the group consisting of a plurality of websites, a plurality of social media platforms, a plurality of product offers, a plurality of service offers, and a plurality of advertisements.

5. The computer-implemented method according to claim 1, wherein the profile information of the user is classified as the user profile table by using one or more of a plurality of machine learning algorithms and a plurality of artificial intelligence algorithms in a storage mechanism.

6. The computer-implemented method according to claim 1, wherein the user classifications related to the user profile table are identified by using one or more of a plurality of machine learning algorithms and a plurality of artificial intelligence algorithms in the storage mechanism.

7. The computer-implemented method according to claim 1, further comprising a step of scoring the user information by using a scoring algorithm.

8. The computer-implemented method according to claim 3, wherein the browsing data is gathered by using a categorization and contextual keyword service to suggest the user to join one or more segments.

9. The computer-implemented method according to claim 1, further comprising classifying a Uniform Resource Locator (URL) associated with the browser extension.

10. The computer-implemented method according to claim 9, wherein the URL is classified to build a plurality of applications.

11. A computer-implemented system for gathering information of a user via a browser extension, the computer-implemented system comprising:
a processor;
a memory communicatively coupled to the processor, wherein the memory stores instructions executed by the processor, wherein the memory and processor are configured to:
receive, by a website associated with the browser extension, profile information of the user;
store, in a database, the profile information of the user as a user profile table;
transmit, by the database, the user profile table to a machine learning database;
identify, by the machine learning database, a plurality of user classifications related to the user profile table;
gather, by the browser extension, browsing data of the user while the user is browsing the internet;
store, in a cloud database server, the browsing data of the user;
determine, by the browser extension, at least one business condition of the user; and
categorize, by the browser extension, the user based on the business condition of the user determined by the browser extension.

12. The computer-implemented system according to claim 1, wherein the business condition determined by the browser extension is indicative of one or more of:
an appropriate business vertical suitable for the user, wherein the appropriate business vertical is selected from a plurality of business verticals;
a current phase of the user within the business verticals; and
a specific segment or a subsegment of the business verticals that the user should belong to.

13. The computer-implemented system according to claim 11, wherein the memory and processor are configured to monitor information of the user to determine segments that the user has not joined.

14. The computer-implemented system according to claim 13, wherein the segments that the user has not joined comprise a plurality of online properties selected from the group consisting of a plurality of websites, a plurality of social media platforms, a plurality of product offers, a plurality of service offers, and a plurality of advertisements.

15. The computer-implemented system according to claim 11, wherein the profile information of the user is classified as the user profile table by using one or more of a plurality of machine learning algorithms and a plurality of artificial intelligence algorithms in a storage mechanism.

16. The computer-implemented system according to claim 11, wherein the user classifications related to the user profile table are identified by using one or more of a plurality of machine learning algorithms and a plurality of artificial intelligence algorithms in the storage mechanism.

17. The computer-implemented system according to claim 11, wherein the memory and processor are configured to score the user information by using a scoring algorithm.

18. The computer-implemented system according to claim 13, wherein the browsing data is gathered by using a categorization and contextual keyword service to suggest the user to join one or more segments.

19. The computer-implemented system according to claim 11, wherein the memory and processor are configured to classify a Uniform Resource Locator (URL) associated with the browser extension.

20. A non-transitory computer-readable storage medium storing executable instructions for generating one or more tailored medical recipes for dementia and mental health disorders that, as a result of being executed by a memory and one or more processors of a computer system, cause the computer system to at least:
receive, by a website associated with the browser extension, profile information of the user;
store and classify, in a database, the profile information of the user as a user profile table;
transmit, by the database, the user profile table to a machine learning database;
create and identify, by the machine learning database, a plurality of user classifications related to the user profile table;
gather, by the browser extension, browsing data of the user while the user is browsing the internet;
store, in a cloud database server, the browsing data of the user;
determine, by the browser extension, at least one business condition of the user; and
categorize, by the browser extension, the user based on the business condition of the user determined by the browser extension.
